(19) United States
(12) Patent Application Publication
(10) Pub. No.: US 2006/0143116 A1
(43) Pub. Date: Jun. 29, 2006

(54) Business analytics strategy transaction reporter method and system

(76) Inventors: Roger Sumner, Batavia, IL (US); Anthony Dezonno, Bloomingdale, IL (US)

Correspondence Address: Welsh & Katz, Ltd.;Richard J. Gurak, 22nd Floor, 120 South Riverside Plaza, Chicago, IL, 60606, US

(21) Appl. No.: 11/022,742

(22) Filed: Dec. 27, 2004

(51) Int. Cl. G06Q 40/00; G06Q 99/00; G06Q 20/00

(52) U.S. Cl. 705/39; 705/1; 705/19

(57) ABSTRACT

A business method and system is provided for reporting routing transactions using business strategy and tactics information. In one embodiment, a contact center evaluator, a routing rules engine and a business rules evaluator are provided. Information may be input into the contact center evaluator from a contact center and to the business rules evaluator from a business system. Further, a routing engine is provided and reports are generated based on business information and decisions made for routing a call or transaction.

### FIELD OF THE INVENTION

The field of the invention relates to a business analytics strategy transaction reporter, and more particularly to a method and system that provides for reporting routing transactions based on business strategy and tactics.

### BACKGROUND OF THE INVENTION

Transaction and call routers and reporters of various types are known in the art. Such devices typically lack the ability to demonstrate how business objectives are met with transaction routers. The present invention overcomes these and other problems inherent in existing transaction routers and reporters. The present invention provides a method and system for reporting routing transactions based on business strategy and tactics. In one embodiment, the method and system can illustrate the impact of strategies on business metrics with an ability to identify how the router selection outcomes meet the objectives of a business strategy.

### SUMMARY

A business method and system is provided for reporting routing transactions using business strategy and tactics information. In one embodiment, a contact center evaluator, a routing rules engine and a business rules evaluator are provided. Information may be input into the contact center evaluator from a contact center and to the business rules evaluator from a business system. Further, a routing engine is provided and reports are generated based on business information and decisions made for routing a call or transaction.

### BRIEF DESCRIPTION OF THE DRAWINGS

FIG. 1 is a block diagram of one embodiment of a reporting system in the contact center evaluator module.

FIG. 2 is a block diagram of one embodiment of an evaluation system derived with four functional blocks.

FIG. 3 is a block diagram of one embodiment showing multiple strategies deployed in parallel against a metric.

FIG. 4 is a block diagram of one embodiment showing a strategy having sub-strategies which have tactics.

FIG. 5 is a block diagram of one embodiment showing generally a life cycle state and importance value for each strategy.

FIG. 6 is a block diagram of one embodiment of a cause and effect business model for a customer satisfaction model.

FIG. 7 is a block diagram of another embodiment showing an overall customer satisfaction model.

FIG. 8 is one embodiment of an influence diagram report.

FIG. 9 is a block diagram of one embodiment of a planner model of a business performance indicator.

FIG. 10 is a block diagram of one embodiment of a model showing how strategies are evaluated for their performance in the overall business environment.

FIG. 10A is one embodiment of a block diagram showing the relationship for technical success and commercial success key factors.

FIG. 11 is one embodiment showing a probability density function to calculate the likelihood of success for each of the strategies.

FIG. 12 is one embodiment a report showing the contribution to a business objective for each of the various strategies.

FIG. 13 is one embodiment of a report showing the amount of impact that a strategy has to the KPI value based on the model.

FIG. 14 is one embodiment of a report showing probability of success and impacts against all lifecycles and strategies.

FIG. 15 is one embodiment of a report showing the impact on a KPI value by a tactic.

FIG. 16 is one embodiment of a report showing the actual KPI value measured from the business system and the model estimated value.

FIG. 17 is one embodiment a report showing actual performance over each period.

FIG. 18 is another embodiment of a report showing actual performance over each period.

FIG. 19 is one embodiment of a report showing how the router selection outcomes meet the objectives of a business strategy.

FIG. 20 is one embodiment of a report showing performance value of tactics over a given period.

FIG. 21 is one embodiment of yet another report showing the contribution of each strategy.

FIG. 22 is one embodiment of a report showing the collected data from the periods to show the strategy for a given period.

FIG. 23 is one embodiment of a strategic detail report.

### DETAILED DESCRIPTION OF A PREFERRED EMBODIMENT

While the present invention is susceptible of embodiments in various forms, there is shown in the drawings and will hereinafter be described some exemplary and non-limiting embodiments, with the understanding that the present disclosure is to be considered an exemplification for the invention and is not intended to limit the invention to the specific embodiments illustrated. In this disclosure, the use of the disjunctive is intended to include the conjunctive. The use of the definite article or indefinite article is not intended to indicate cardinality. In particular, a reference to “the” object or “a” object is intended to denote also one of a possible plurality of such objects.

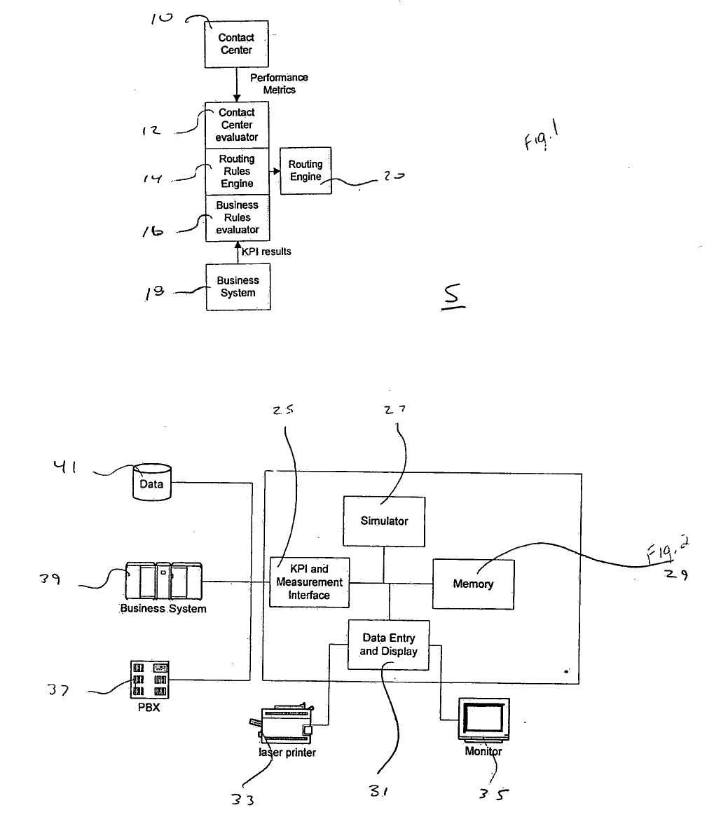

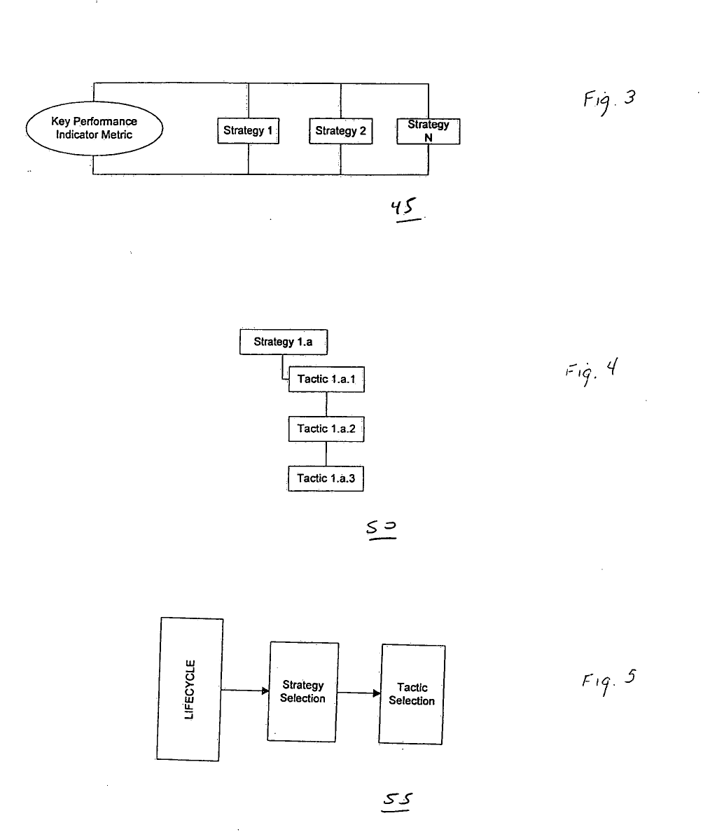

FIG. 1 shows a block diagram of one embodiment of a reporting system in the contact center evaluator module. In one embodiment, the system provides for routing transactions and calls based on business strategy and tactics. In this system, information from the contact center 10, the routing rules engine 14 and the business rules evaluator 16 is collected and reported on from the contact center evaluator 12 or the business rules evaluator 16. Overall, the evaluator system, in one embodiment, can be derived with 4 functional blocks: data entry and display 31 process, KPI and measurement interface 25, a simulator 27, and memory 29 as shown in FIG. 2. Further provided may be printers 33, monitors 35, PBX 37, business systems 39 and data means 41.

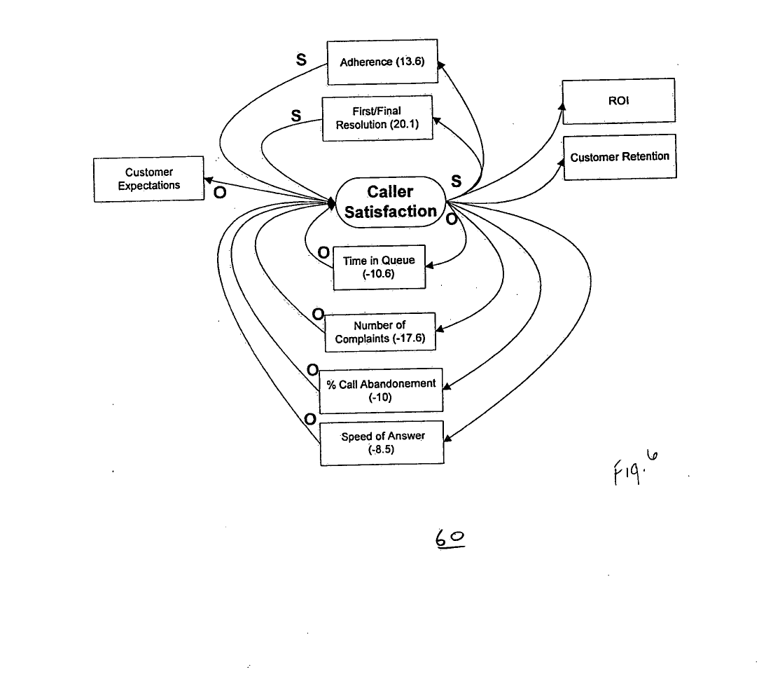

Strategies may be created and deployed as a mechanism of improving the values of a business key performance indicator. In one embodiment, the role of the strategy is to positively drive the metric to a desired value. Multiple strategies may be deployed over a given period of time, in parallel as shown in block diagram 45 in FIG. 3, against the metric to further improve, or to prevent the deterioration, of a metric value. In one embodiment of this model, a strategy may incorporate a multiplicity of tactics as seen in block diagram 50 in FIG. 4. Execution of the tactics results in the completion of the strategy. Partial completion of tactics may result in a partial attainment of a change in a strategic value. Additionally, a strategy may have sub-strategies that in and of themselves have additional tactics that are executed to fulfill the sub-strategy. In one embodiment, a lifecycle state and importance value may be associated to each strategy. At different points in a system lifecycle, the likeliness of success of a strategy may depend upon the life stage of the system. For example, as shown in block diagram 55 in FIG. 5, a new strategy designed to increase, for example, vacuum tube sales may likely fail. In this case, a strategy to increase sales of a product that is in an obsolescence phase has a low probability of success.

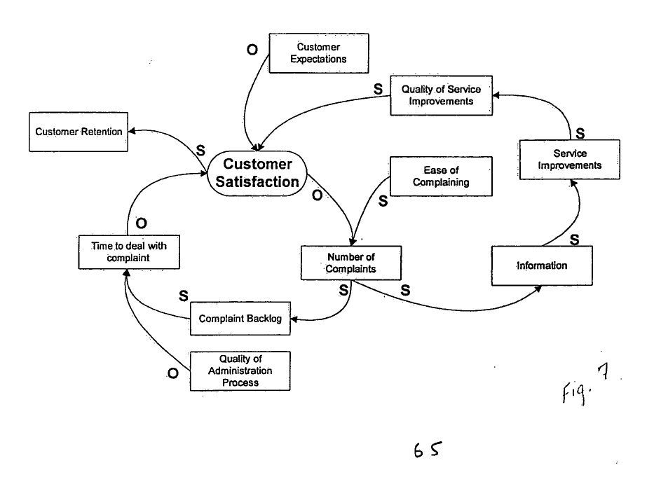

Shown in block diagram 60 in FIG. 6 is a cause and effect business model for a customer satisfaction key performance indicator metric. This model is partially supported by statistics from the Purdue Research Foundation describing the impact, shown in parenthesis, of various contact center statistics on the business metric of caller satisfaction. An illustration may be depicted to show the relationship between metric values and that this model contains the metrics associated with measuring a customer satisfaction value. This diagram may be directly entered into the business reporting system. The relationship to other metrics may be shown as links between the metrics with an associated mathematical indicator, such as S for “supports”, or O for “opposes”. For example, an increase in customer satisfaction is shown as a decrease (opposition) of the number of complaints in the system. Similarly, an increase in the number of complaints will be shown as an increase in the complaint (supports) backlog. A “Support” relationship is equivalent to a linear addition or multiplication operation. An “Opposes” relationship is analogous to a subtraction, inverse or division. Additional outside metrics may also affect the model, such as customer expectations, and likewise the model may also have effects on additional metrics such as customer retention.

Positive scoring drivers in support of caller satisfaction are shown on the top of the diagram; whereas, negative scoring drivers are shown in the bottom portion of the diagram. ROI, customer retention, and customer expectations are business metrics driven by changes in the customer satisfaction score that may be estimated from the model. Each branch of this model represents a path for a major strategic initiative that can be synthesized through adding additional metrics that are then the target for sub-strategies and with tactics to implement them. Additional metrics can be put in each major strategic path to increase the level of granularity of the reporting system to determine additional required strategies and proper model alignment with business practices. Statistics from existing research imply that creating and deploying strategies to support first/final call resolution would yield the largest impact on the overall business model. One possible tactic to be described in the first/final call resolution strategy is the procurement of additional equipment that would achieve this objective goal.

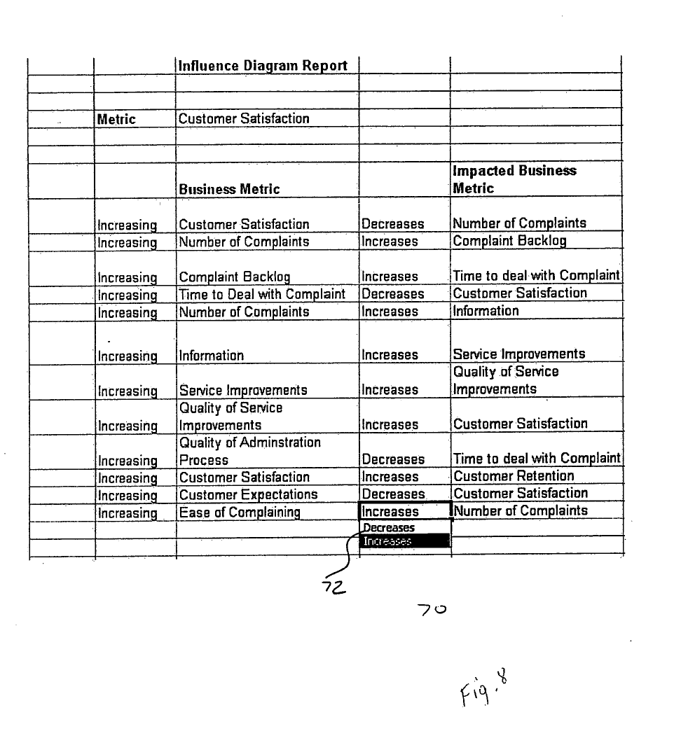

Another diagram illustrating an overall customer satisfaction model 65 is shown in FIG. 7. Source: Next Generation Scorecards, DM review, December 2001. This is an iterative model where changes in key performance indicators drive the value of other business metrics. The results in designing a business strategy to increase customer satisfaction, for example, will depend on the performance of the model. The contact center evaluator will take this inputted model and create an influence diagram report. This report will show the linkages between the various metrics in a tabular format as shown in table 70 in FIG. 8.

In one embodiment, the report will have a pull-down menu 72, as shown in FIG. 8 on the last line to allow a user to change the relationship between the metrics from increases (supports) to decreases (opposes) and will update the model accordingly. For clarity, the report can show a singular direction of all of the business metrics so that the relationships can be more easily read and understood. Ideally, showing the metric as increasing and indicating the result on the impacted or linked business metric fulfills this requirement. The reporting system may also illustrate a planner model of the business performance indicator. With this view, the inputs to the model, such as customer expectations, are shown together with the other inputs to the model. Likewise model outputs, such as customer retention, are shown as a collective linkage from the key performance indicator. The original graphical model is then transverse per linkage to display paths through the model. A path is complete once it returns to the performance metric or to a point that has already been chartered.

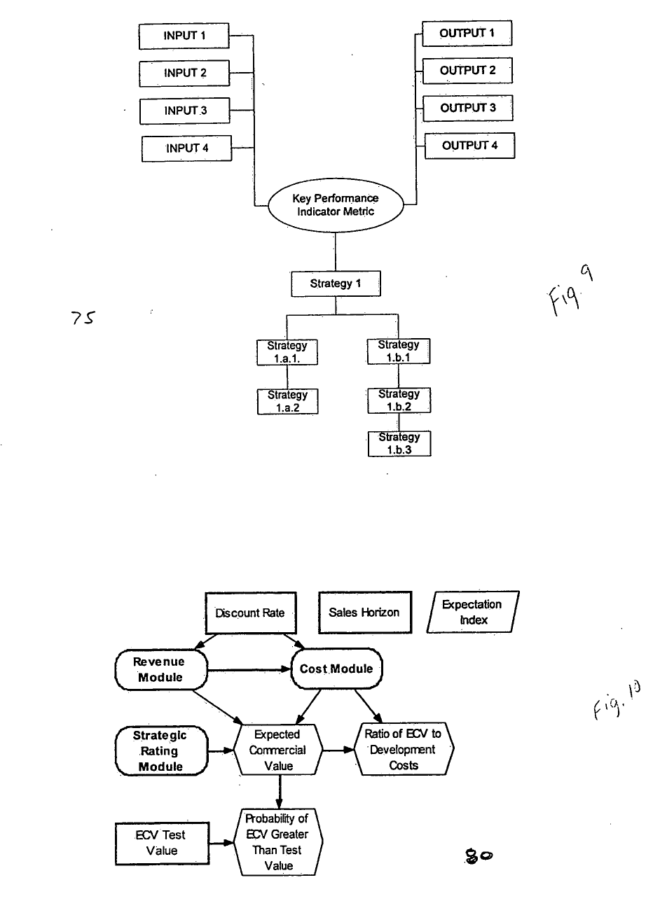

In the graphically entered model 75 as shown in FIG. 9, the key performance indicator is the metric of customer satisfaction. This has a linkage to “number of complaints” and since it is the first linkage it may be designated as the first strategy. Alternately, it is possible to indicate that the model is associated as a strategy when it is drawn in the diagram. As this has an opposing relationship with “customer satisfaction”, a strategic goal to increase customer satisfaction must result in a decrease in the number of complaints. The model can also be seen to show that a change in the number of complaints drives two sub-strategies affecting the business metrics of complaint backlog and information. This model may then be shown as an alternate textual report, as shown in Report 1, to showing the above relationships.

Report 1

| | |
|---|---|
| GOAL. | Improve Customer Satisfaction |
| INPUTS: | Time to deal with complaint |
| | Customer Expectations |
| | Ease of complaining |
| | Quality of Adminstartion process |
| | Customer Sat KPI (t) current |
| OUTPUTS: | CUSTOMER SAT KPI |
| | CUSTOMER RETENTION KPI |
| STRATEGY: | 1. Reduce Number of complaints |
| | 1.a.1 Reduce Complaint backlog |
| | 1.a.2 Reduce Time to deal with complaint |
| | 1.b.1 Increase Information |
| | 1.b.2 Increase Service Improvements |
| | 1.b.3 Increase Quality of service improvements |

Model inputs and outputs are collectively shown as variables to the tabular text representation. This model may be exported or imported in an XML format for processing by the system. The current value of the business metric at time (T) is also shown as an input to the model. A goal is created to represent the function of the model. Finally, the strategy is shown as separate line entries and labeled with designators. In this example, “1. Reduce Number of complaints:” has 2 sub-strategies 1.a.1 and 1.a.2. The “Reducing Complaint backlog” sub-strategy requires tactics to be assigned to implement the sub-strategy. The structure of this report may be sent to a KBO management system for direct creation of performance plans to achieve the desired outcome. Sub-strategy tactics are enterable by the user or predefined standard model tactics may be assigned in the system as described in other disclosures. The system should then use this strategic information as part of a simulation model for the overall business system operation.

In model 80 shown in FIG. 10, the strategies may then be evaluated for their performance in the overall business environment. This is calculated in the strategic rating module. Note that additional business metrics such as ROI or expected commercial value of the strategy and tactics may be calculated with this approach. Inside the strategic planning module is a way of evaluating each strategy. An administrator rates aspects of the strategy along multiple dimensions such as technical success and commercial success for the attributes of the strategy. This may also be applied to tactics that are used in each strategy. Additional dimensions of success factors may be added specific to a business environment. For example, a market entry success analyzer may be added to inspect factors such as market conditions, firm conditions, corporate culture, and proprietary protection to determine market entry success. A ranking system may be created for each of the applicable dimensions. Further, actual performance values such as an actual value or industry standard i.e., 10% decrease in call abandonment results in an increase of $1M in sales/year, may be used as a rating measure.

Sample Rating Measure
Technology Gap:

| Score | |
|---|---|
| 1 | Large gap between current practice and objective must |
| | invent new science. |
| 4 | “Order-of-magnitude” changes proposed. |
| 7 | Step change, but short of “order-of-magnitude.” |
| 10 | Incremental improvement. |

Further, as shown block diagram 85, in FIG. 10A, technical and commercial success key factors are illustrated with their rating measure. Some of the technical success factors may include, for example, technical gap, program complexity, technology skill base and availability of resources. A technical success score rating is calculated as a sum of all technical success factors to give overall measure of technical success for each strategy and tactic. One way to evaluate the aspects of the strategy for commercial success includes the following success factors: commercial success factors, market need, market maturity, competitive intensity, commercial applications development skills and commercial assumption.

In one embodiment, the commercial success rating is calculated as a sum of all commercial success factors to give overall measure of commercial success for each strategy and tactic. Once these, and any other success factor dimensions suitable for the model are entered into the model, the likelihood of success is calculated in the model. The probability of success module can use a beta probability model distribution to represent the uncertainty in estimates of the probability of success. This model creates a probability of success based on the assessment ratings entered versus the maximum possible ratings. An example of one formula to assist with this derivation is:

### Formula

Beta(success_rating,10*((scss_key_factors)−success_rating)

Where Beta is defined as:
=∫₀¹x^{A-1}(1−x)^{B-1}dx
The parameter A=Success Rating
B=Maximum possible Success Rating−Success Rating

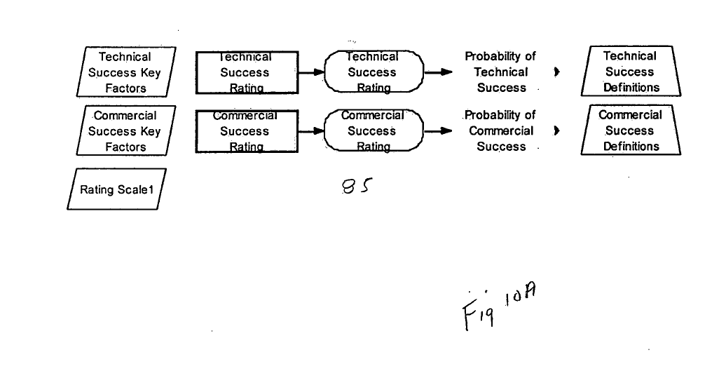

A report 90, as shown in FIG. 11, illustrates one form of a probability density function to calculate the likelihood of success and may be generated for each of the strategies. Another report 95 view as shown in FIG. 12 may then be calculated showing the contribution to a business objective for each of the various strategies. As shown, strategy 6 yields the highest impact of all the strategies under analysis. Ideally, the system will chose and propose the maximum benefit strategy for implementation within the business structure. Multiple strategies may be selected for implementation depending upon the availability of resources required to execute the strategy.

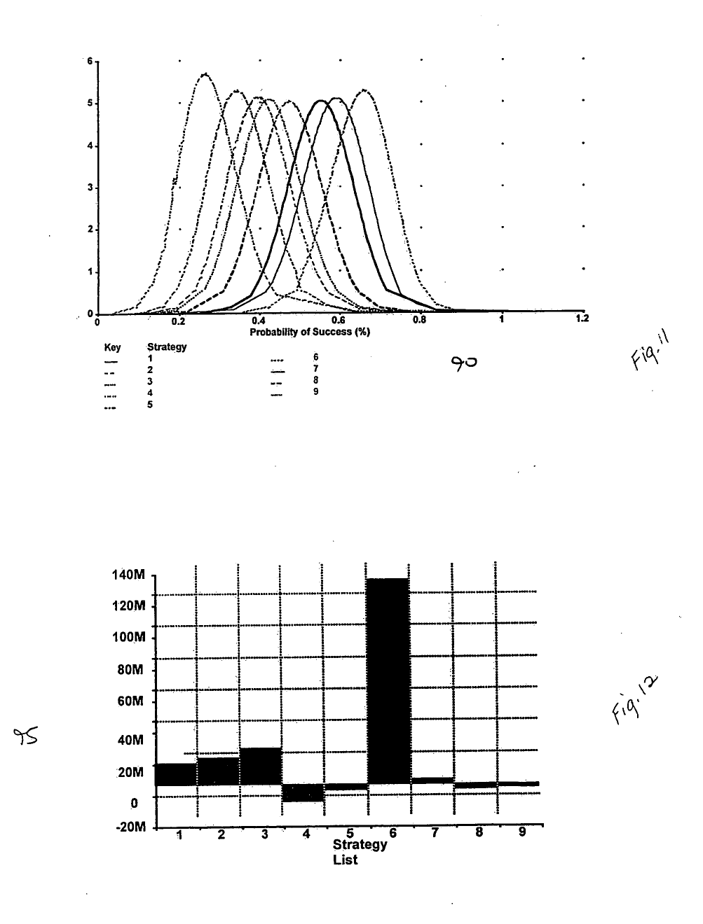

A report 100 running a ranked correlation of each strategy against the model KPI variables, as shown in FIG. 13, can be executed to show the amount of impact that a strategy has to the KPI value based on the model. Collectively, a report can be run showing the probability of success and impacts against all lifecycles and strategies available. As can be seen in the report 110, in FIG. 14, different strategies have different performance attributes based on the lifecycle of the system. Strategy A is shown with decreasing probabilities based on the lifecycle of the system it is being applied against. The impact of each strategy on KPI values along with rolled up FTE and cost estimates of tactics associated with the strategy are displayed in this report. This information may also be sent to a geometrical graphical display for visual or printed output to a user to indicate the relative ranking of various strategies to a user.

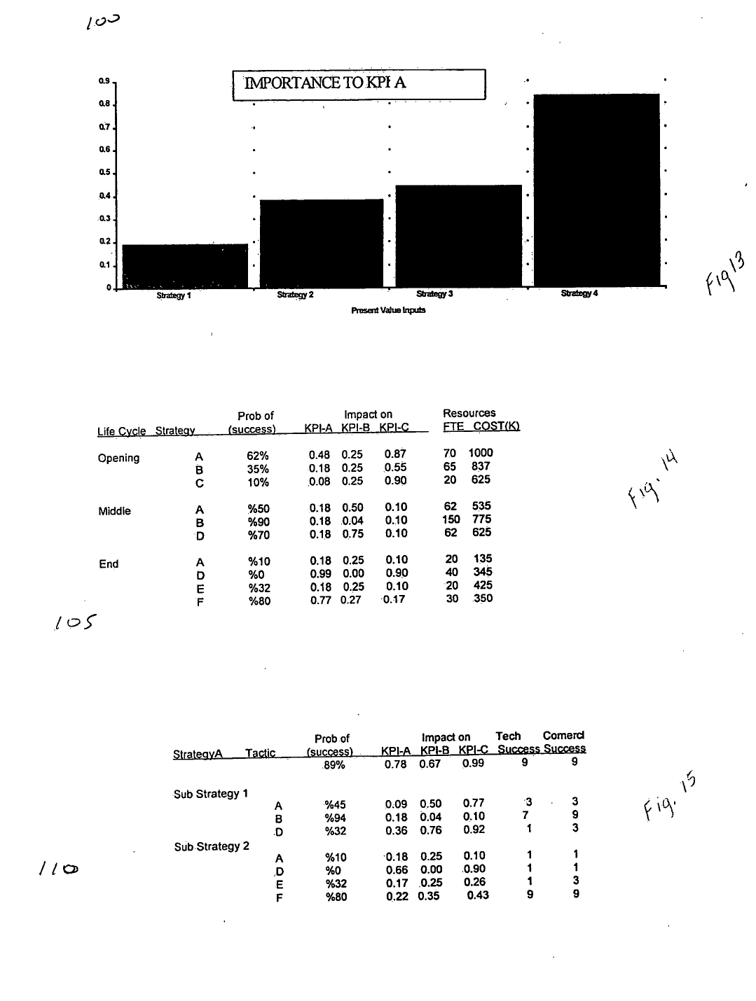

The impact on a KPI value by a tactic may also be calculated from the model and displayed as a report 110 as shown in FIG. 15. A drill down of particular strategies will indicate in a similar fashion associated tactics and the impact of the tactics on KPI values along with rating values in a report. A mathematical function may also describe the contribution function of a tactic so that if a tactic is not fully completed but still has an impact on a KPI over a period, the contribution from the tactic may be included. Other tactics, such as positional tactics, may not have direct or immediate connection to a KPI value, and could have a unitary contribution of one (1).

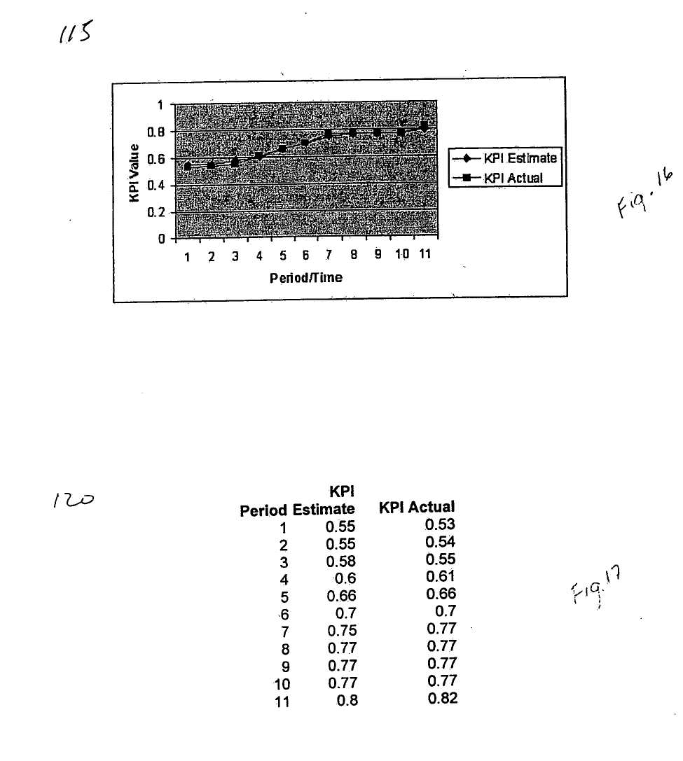

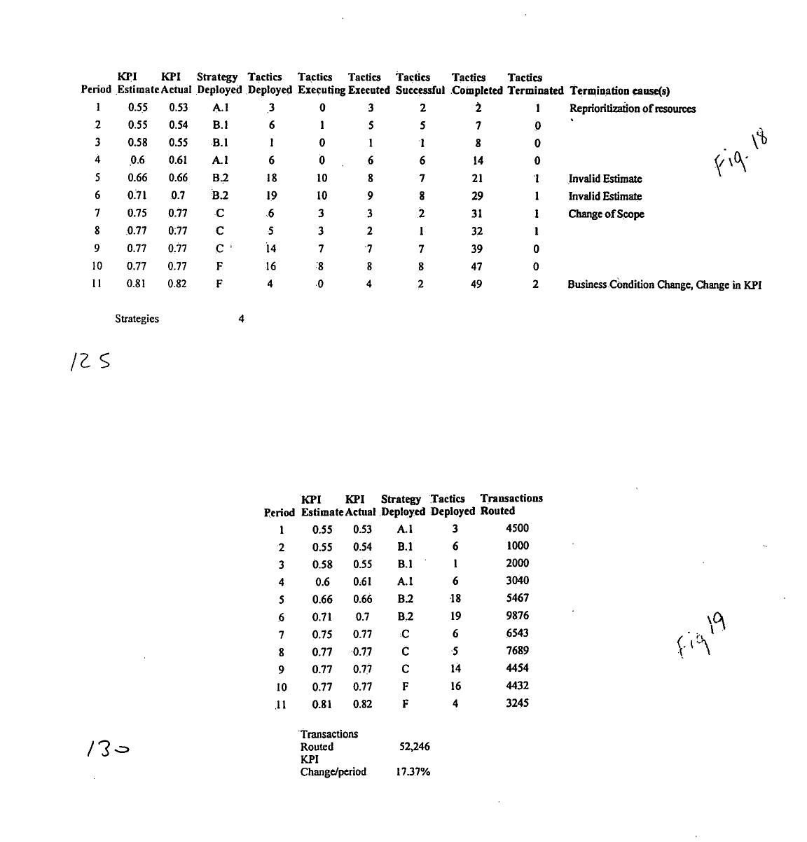

When the system is deployed, in one form, another report 115 will indicate for each of the KPI values, the actual KPI value measured from the business system and the model estimated value as shown in FIG. 16. In one embodiment, each of the KPI values will have a report showing actual performance over each period. This may also be shown in a tabular report 120 as shown in FIG. 17. As the system operates, a report 125 showing the strategies and tactics used during a period will be available as shown in FIG. 18.

In one embodiment, the following are example of field definitions: (1) Strategy Deployed: The strategy being utilized in a period; (2) Tactics Deployed: The total number of tactics acted on with the period as defined by Tactics Executing+Tactics executed; (3) Tactics Executing: Number of tactics still underway at the end of the reporting period; (4) Tactics Executed: Number of tactics that have finished; (5) Tactics Successful: Tactics achieving 100% completion or success; (6) Tactics Completed: Sum of all Tactics Successful over a period; (7) Tactics Terminated: Number of tactics that were stopped during the period; and (8) Termination Reason: Codes indicating why tactics were unsuccessful.

A further detail of reporting as shown in report 130 of FIG. 19 illustrates how the router selection outcomes meet the objectives of a business strategy. Details about the number of transactions and the associated tactics and strategy deployed are displayed to the user. Similarly, a report indexed by transaction ID may be assembled to show the tactic chosen and the strategy used for the routing of the transaction. In one embodiment, the format of the report shows:

Transaction ID

Route based on

Tactic based on

Sub-strategy based on

Strategy

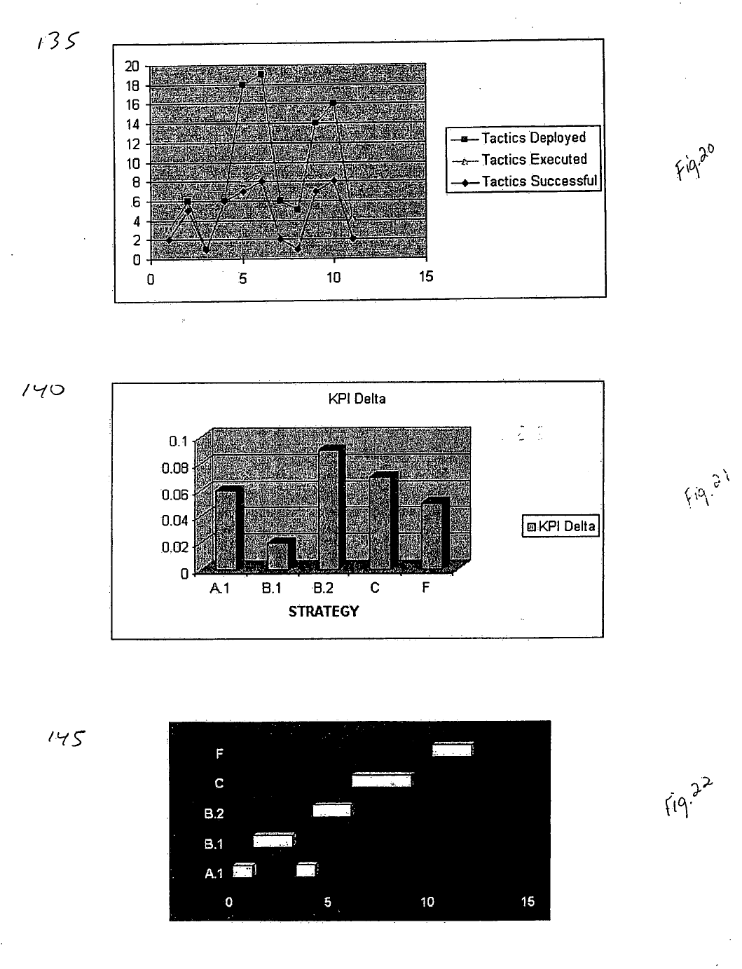

Strategies, like A.1, may be deployed multiple times during a period. Tactics that are executing at the end of a period are considered deployed into the next period. A period may end either on a fixed time basis or on a change in a system state variable, such as a KPI measurement changing. More so, the model may be configured to specify a decision point to terminate a tactic if certain performance improvements in KPI do not occur within a period of time and begin the execution of a different tactic. The system may be programmed, in one embodiment, to select the next most probabilistically likely tactics to meet the needs of the strategy. Once a tactic has been terminated in a period, the performance value of the tactic over the period will be used as an actual impact value for the tactic. Additional reports 135 are available from the reporting system in the contact center evaluator based on this data collection as shown in FIG. 20. The actual contribution of each strategy is then concentrated from the period report information as shown in report 140 of FIG. 21. In this example, both of the contributions from the period of time where Strategy A.1 is executing would be added together to give the sum result. In the case where multiple strategies are concurrently executing and impacting the same KPI, the amount of KPI delta is allocated among the executing strategies, preferably by a ratio from the importance correlation report.

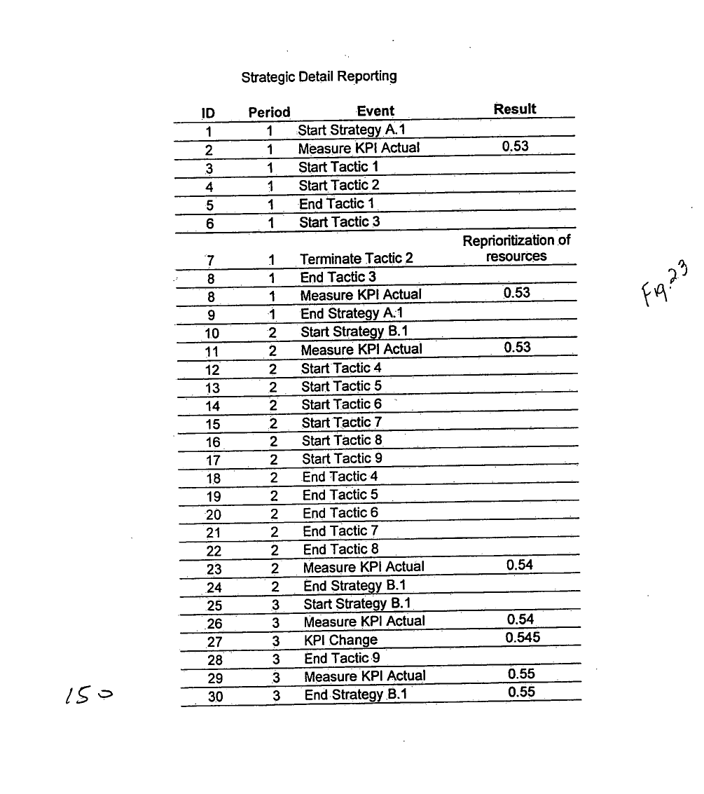

Further, as shown in report 145, FIG. 22, in one embodiment the system may report on the strategy deployed over various periods of time. In this report, the data from the periods is collected and formatted to show the strategy used for a given period. Furthermore, as shown in table 150 in FIG. 23 the system will present and store in memory a strategic detail report when under operation. In the contact center evaluator, information from this report will be written to a database for additional processing. A record is kept for each strategy and tactic deployed in the system. Also, as strategies begin, KPI values are measured at the beginning of the period. KPI values are also collected when they change in the business system as part of the record keeping operation and when strategies are ended. A result code for ending a tactic is stored for reporting purposes, as the operator or the system may stop tactic execution.

Specific embodiments of novel methods and apparatus for construction of novel business analytics strategy transaction reporters according to the present invention have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention any and all modifications, variations, or equivalents that fall within the true spirit and scope of the basic underlying principles disclosed and claimed herein.

What is claimed is:

1. A method for reporting routing transactions using information collected from a transaction routing system, said method comprising the steps of:
providing a transaction routing system comprised of a contact center, a contact center evaluator, a routing rules engine and a business rules evaluator configured to generate routing transaction decisions based on inputted information; and
reporting routing transactions based on the generated decisions.

2. The method of claim 1 further comprising the step of collecting information from the contact center and generating a report on the information.

3. The method of claim 1 further comprising the steps of collecting information from the business rules evaluator and generating a report on the information.

4. The method of claim 3 further comprising the step of providing an iterative model that shows how changes in key performance indicators affect the value of business metrics.

5. The method of claim 4 further comprising the step of designing a business strategy based on performance of the model.

6. The method of claim 4 further comprising the step of inputting the model into the contact center evaluator and creating an influence diagram report.

7. The method of claim 6 wherein the influence diagram report shows a singular direction of all of the business metrics.

8. The method of claim 5 further comprising the step of creating a report to illustrate a planner model of a business performance indicator.

9. The method of claim 8 further comprising the step of showing the planner model as a textual report providing the relationships among inputs, outputs, strategies and the business performance indicator.

10. The method of claim 1 further comprising the step of providing a strategic rating module for evaluating strategies for their performance in a business environment.

11. The method of claim 10 further comprising the step of providing a strategic planning module for rating a strategy according to technical and commercial success.

12. The method of claim 11 further comprising the step of calculating and generating a report on a commercial success rating as a sum of all commercial success.

13. The method of claim 12 further comprising the step of generating a report showing a probability density function to calculate the likelihood of success for each of the strategies.

14. The method of claim 11 further comprising the step of generating a report showing the contribution to a business objective for each of the strategies.

15. The method of claim 11 further comprising the step of generating a report showing the amount of impact that a strategy has to the performance indicator value based on the model.

16. The method of claim 11 further comprising the step of generating a report showing probability of success and impacts against all lifecycles and strategies available.

17. The method of claim 11 further comprising the step of generating a report showing the impact on a performance indicator value by the tactic.

18. The method of claim 11 further comprising the step of generating a report indicating the actual performance indicator value measured from the business system and model estimated value.

19. The method of claim 18 further comprising the step of generating a report showing for each performance value the actual performance over a given period.

20. The method of claim 11 further comprising the step of generating a report illustrating how the router selection outcomes meet the objectives of a business strategy.

21. The method of claim 11 further comprising the step of generating a report indexed by transaction identification to show the chosen tactic and the strategy used for routing of the transaction.

22. The method of claim 21 further comprising the step of generating a report showing the strategy used for a given period.

23. The method of claim 11 further comprising the step of storing a strategic detail report for each tactic and strategy.

24. A method for reporting routing transactions using business strategy and tactics information, said method comprising the steps of:
providing a contact center evaluator, a routing rules engine and a business rules evaluator;
inputting information to the contact center evaluator from a contact center;
inputting information to the business rules evaluator from a business system;
providing a routing engine and generating decisions for routing a transaction based on information from the routing rules engine; and
reporting routing transactions based on the generated decisions.

25. The method of claim 24 further comprising the steps of collecting information from the contact center and creating a report on the information.

26. The method of claim 25 further comprising the step of providing an interactive model that shows how changes in key performance indicators affect the value of business metrics.

27. The method of claim 26 further comprising the step of designing a business strategy based on performance of the model.

28. The method of claim 26 further comprising the step of inputting the model into the contact center evaluator and creating an influence diagram report.

29. The method of claim 28 wherein the influence diagram report shows a singular direction of all of the business metrics.

30. The method of claim 27 further comprising the step of the step of creating a report to illustrate a planner model of a business performance indicator.

31. The method of claim 30 further comprising showing the planner model as a textual report providing the relationships among inputs, outputs, strategies and the business performance indicator.

32. The method of claim 24 further comprising the step of providing a strategic rating module for evaluating strategies for their performance in a business environment.

33. The method of claim 32 further comprising the step of providing a strategic planning module for rating a strategy according to technical and commercial success.

34. The method of claim 33 further comprising the step of calculating a commercial success rating as a sum of all commercial success.

35. The method of claim 34 further comprising the step of generating a report showing a probability density function to calculate the likelihood of success for each of the strategies.

36. The method of claim 33 further comprising the step of generating a report showing the contribution to a business objective for each of the strategies.

37. The method of claim 33 further comprising the step of generating a report showing the amount of impact that a strategy has to the performance indicator value based on the model.

38. The method of claim 33 further comprising the step of generating a report showing probability of success and impacts against all lifecycles and strategies available.

39. The method of claim 33 further comprising the step of generating a report showing the impact on a performance indicator value by the tactic.

40. The method of claim 33 further comprising the step of generating a report indicating the actual performance indicator value measured from the business system and model estimated value.

41. The method of claim 40 further comprising the step of generating a report showing for each performance value the actual performance over a given period.

42. The method of claim 33 further comprising the step of generating a report illustrating how the router selection outcomes meet the objectives of a business strategy.

43. The method of claim 33 further comprising the step of generating a report indexed by transaction identification to show the chosen tactic and the strategy used for routing of the transaction.

44. The method of claim 43 further comprising the step of generating a report showing the strategy used for a given period.

45. The method of claim 33 further comprising the step of storing a strategic detail report for each tactic and strategy.

46. A method for routing and reporting routing transactions using business strategy and tactics information, said method comprising the steps of:
providing a contact center evaluator, a routing rules engine and a business rules evaluator;
inputting information to the contact center evaluator from a contact center;
inputting information to the business rules evaluator from a business system;
providing a routing engine and generating decisions for routing a transaction based on information from the routing rules engine; and
reporting routing transactions based on the generated decisions.

47. The method of claim 46 further comprising the step of determining the business system information by accessing a simulator, a memory means, a data entry and display means and a key performance indicator and measurement interface.

48. The method of claim 47 further comprising the step of implementing strategies as a way to improve the values of a key performance indicator.

49. The method of claim 47 further comprising the step of implementing multiple strategies in parallel against a key performance indicator to improve a metric value.

50. The method of claim 47 further comprising the step of implementing multiple strategies in parallel against a key performance indicator to prevent deterioration of a metric value.

51. The method of claim 48 further comprising the step of providing multiple tactics for a strategy.
